(19) United States
(12) Patent Application Publication
(10) Pub. No.: US 2020/0410582 A1
(43) Pub. Date: Dec. 31, 2020

(54) Preventing Impersonation of Users in a Transaction System

(71) Applicant: PayPal, Inc., San Jose, CA (US)

(72) Inventor: Megan Marie O'Neill, San Jose, CA (US)

(21) Appl. No.: 16/458,052

(22) Filed: Jun. 29, 2019

(51) Int. Cl. G06Q 40/02; G06F 16/9535; G06N 20/00

(52) U.S. Cl. CPC G06Q 40/02; G06N 20/00; G06F 16/9535

(57) ABSTRACT

Techniques are disclosed for preventing impersonation of users in a transaction system. One method includes receiving, at a computer system, a request to change profile information associated with a particular user having an account with a transaction system. In response to receiving the request, the computer system accesses a database that identifies potential targets that may be impersonated using the transaction service. If the access to the database results in a determination that the profile data in the request matches one or more of the potential targets stored therein, one or more restrictions is placed on the request being able to complete.

### BACKGROUND

### Technical Field

This disclosure is directed to transaction systems, and more particularly, to preventing users of the transaction system from being impersonated by others.

### Description of the Related Art

Transaction processing systems are ubiquitous today and provide a wide variety of services to users. These services can include social networks, file transfer services, and any other type of service in which two or more users can conduct transactions with one another. Another type of service that may be provided is a payment service, which may facilitate electronic payment transfers. Account holders may use a transaction processing service to pay for goods and services electronically, donate to causes, transfer money to family and friends, and the like.

Users of a transaction processing service may submit profile information used for identification and establishing the account. Such profile information may include the user's name, a username (which may be different than the real name), the user's location, and other identifying information, such as a photograph. This information may be updated from time to time, and may be augmented with information such as transaction history as the user utilizes the service.

### SUMMARY

Techniques are disclosed for preventing impersonation of users in a transaction system. In one embodiment, a method includes receiving, at a computer system, a request to change profile information associated with a particular user having an account with a transaction system. In response to receiving the request, the computer system accesses a database that identifies potential targets that may be impersonated using the transaction service. If the access to the database results in a determination that the profile data in the request matches one or more of the potential targets stored therein, one or more restrictions is placed on the request being able to complete.

In various embodiments, responding to a request to change profile information can result in various outcomes. One outcome is that a request to update profile information is approved. This may occur when there are no substantial matches between the identity of the user making the request (as reflected in the requested profile change) and that of a potential target in the database. Another outcome results neither in an initial denial or initial approval, but rather, a request for further identifying information from the user requesting the profile change. This may occur when some data associated with the update matches that of a user in the potential target database (e.g., such as a common name), but the match is not substantial enough for immediate denial of the request. Yet another outcome is that the request may be denied. This may occur when the request would result in the corresponding profile would substantially match an identity in the potential target database. Denying such requests may prevent what is commonly referred to as “spoofing,” where a user misrepresents or disguises their identity to another unsuspecting party. Such misrepresentation of a user's true identity is frequently used to commit online fraud, particularly through payment service providers.

In various embodiments, the potential target database may be populated based on the operation of an Internet bot. The Internet bot may scan various websites, such as news websites, crowdfunding sites, social networks, and any other Internet site of interest. Upon identifying a person or entity of interest that is a potential target for fraud (e.g., an individual identified in a news story as having a financial need), the Internet bot may update the potential target database with relevant information. This information may include the name of an individual, and any relevant metadata, such as photographs, location information, type of event that caused the identification by the Internet bot (e.g., financial distress), etc. This information can then added to a potential target database and used during attempts to change profile information of existing users or add profile information for a new user to prevent the impersonation of potential targets.

### BRIEF DESCRIPTION OF THE DRAWINGS

The following detailed description makes reference to the accompanying drawings, which are now briefly described.

FIG. 1 is a block diagram of one embodiment of a system used to prevent impersonation of users in a transaction system.

FIG. 2 is a block diagram of one embodiment of an Internet scan bot.

FIG. 3 is a block diagram of one embodiment of a potential target database module.

FIG. 4 is a block diagram of one embodiment of a transaction services user database module.

FIG. 5 is a block diagram of one embodiment of a profile change module.

FIG. 6 is a block diagram illustrating the operation of one embodiment of an Internet scan bot.

FIG. 7 is a block diagram illustrating operation of one embodiment of a profile change module when an existing user of a transaction processing service attempts to update their respective profile.

FIG. 8 is a block diagram illustrating operation of one embodiment of a profile change module when a new user of a transaction processing service attempts to add a new profile.

FIG. 9 is a flow diagram illustrating one embodiment of a method for determining whether a user is attempting to use their profile to impersonate another identity.

FIG. 10 is a flow diagram illustrating one embodiment of a method of operating an Internet bot to identify potential targets for impersonation.

FIG. 11 is a block diagram of one embodiment of a computer system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that an element is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors.

As used herein, the terms “first,” “second,” etc. are used as labels for nouns that they precede, and do not imply any type of ordering (e.g., spatial, temporal, logical, etc.), unless stated otherwise.

In the following description, numerous specific details are set forth to provide a thorough understanding of the disclosed embodiments. One having ordinary skill in the art, however, should recognize that aspects of disclosed embodiments might be practiced without these specific details. In some instances, well-known, structures, computer program instructions, and techniques have not been shown in detail to avoid obscuring the disclosed embodiments.

### DETAILED DESCRIPTION OF EMBODIMENTS

The present disclosure is directed to various techniques for preventing impersonation of users in a transaction system. In various types of transaction systems (e.g., payment processing systems, social networks, etc.), some users may try to impersonate others for fraudulent purposes. One recent example illustrates this problem. In the National Football League playoffs following the 2018 season, Chicago Bears kicker Cody Parkey missed a field goal attempt that, if made, would have given his team a victory over the Philadelphia Eagles. Following the game, a number of Eagles fans, happy with Parkey's missed field goal attempt, began to donate small sums of money to Parkey through a payment processing service. When media outlets reported on this news, a number of users of the payment processing service maliciously began to attempt to change their profiles in order to impersonate (or “spoof”) Parkey, such as by changing their profile information to read “Cody Parkey, Chicago, Ill., NFL Kicker.” The motivation for these changes was to trick other users into thinking they were conducting a transaction with the real Cody Parkey, thus allowing the user conducting these profile changes to fraudulently obtain some of Parkey's donations. The present disclosure contemplates various techniques that would help prevent this type of fraudulent activity by reducing its prevalence.

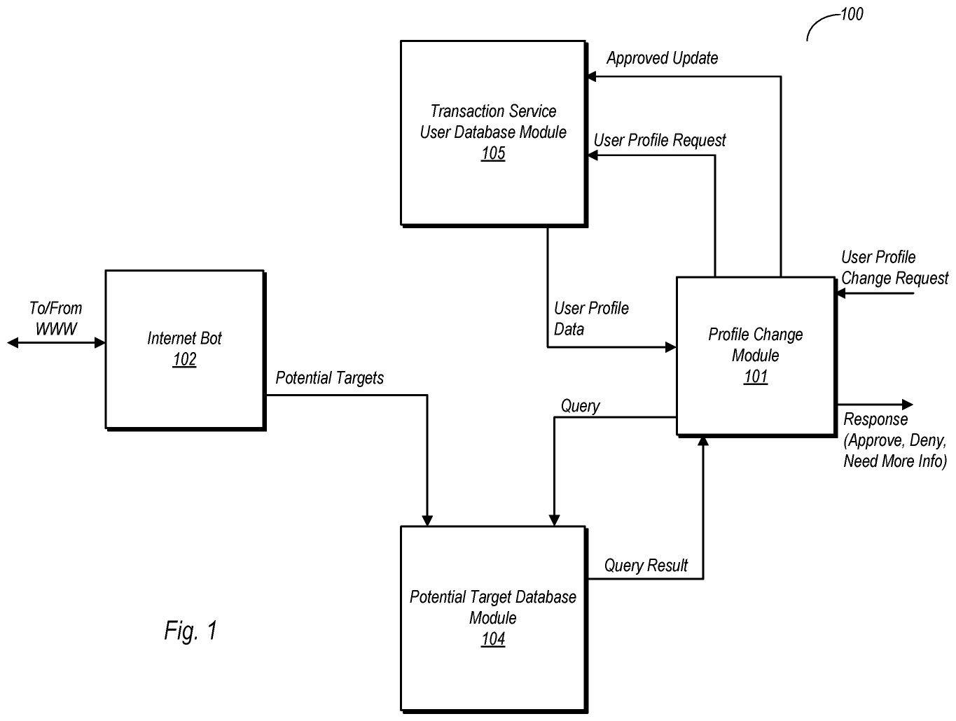

The overall approach described herein has two main components: 1) populating a database of potential targets for impersonation/spoofing, and 2) using the information in the database to prevent other users of the transaction service from impersonating potential targets. In various embodiments, the first component includes an Internet bot scanning various websites (e.g., news sites, social media sites, crowdfunding sites, etc.) to obtain information regarding people and entities that are potential targets for impersonation. When a person/entity is identified by the Internet bot as a potential target, their information obtained from various websites is stored in a potential target database. The second component includes using a profile update module to determine when requested profile changes from existing users changing their profile or new users adding a profile matches information stored in the potential target database. The outcome of a query initiated responsive to a request can include approval of the update request (when little or no information corresponding to the request matches that of a potential target), denial of the request (when there is a significant match between the updated information and information for a potential target), or a request for additional information. This last instance may occur when some information matches that of a potential target, but the match is not significant enough to issue a denial of the request nor insignificant enough to immediately approve. The request for additional information may thus be a request to the user to provide information that can verify that the person/identity requesting update is genuine. Various embodiments that carry out these tasks are now discussed in further detail with respect to FIGS. 1-11.

FIG. 1 is a block diagram of one embodiment of a system used to prevent impersonation of users in a transaction system. In the embodiment shown, transaction system 100 includes a profile change module 101, an internet bot 102, a potential target database module 104, and an internet bot 102.

In various embodiments, different computer systems within entities may implement the various “modules” shown in FIG. 1 (including Internet bot 102). As used herein, the term “module” refers to circuitry configured to perform specified operations, or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Profile change module 101 in the embodiment shown performs various functions related to changes to profiles for transaction system 100. Such changes may include adding new profiles as well as updating existing profiles. As defined herein, a profile is a set of information regarding a particular entity having an account with the transaction service provider. The entity may be an individual person or an organization (e.g., a charity, company, or some other organization). Information included in a profile may include a name of the entity, any relevant photos, location information (e.g., hometown of an individual person), age, gender, transaction history, and any other relevant information, including information that can be used for identification, such as job title or description.

As used herein, transaction system 100 may implement any service in which two or more parties use computer systems to exchange information. Accordingly, a transaction service provider according to this disclosure may include a payment service provider (e.g., PAYPAL), a social network provider, a file transfer service, an online retailer, a dating site, and so on. In various embodiments, users may obtain accounts with the transaction service provider whose service they wish to use. The act of obtaining an account for a transaction service provider will typically include a user/entity providing some identifying information to the service, which is referred to as the “user profile” for that user.

Profile change module 101 in the embodiment shown receives user profile change requests. A profile change request may be a request for the addition of a profile for a new account with the transaction service provider or a request to change a profile for an existing user of the transaction service provider. Upon receiving a request for a profile change, profile change module 101 conducts a query of a potential target database implemented in potential target database module 104.

In the embodiment shown, potential target database module 104 includes a database having entries corresponding to entities that are considered to be potential targets for impersonation, which may be referred to in the computer context as “spoofing.” In a transaction service, malicious actors may attempt, through their profiles to impersonate others in order to benefit from fraudulent transactions. For example, in a payment service, a malicious actor may try to impersonate an individual who is soliciting donations for a charitable cause with the goal of receiving funds that were intended for that individual. Such individuals (as will be discussed below) may be designated by system 101 as potential targets for this type of impersonation, and information corresponding thereto may be stored in the potential target database. Accordingly, when profile change module 101 receives a request to change a profile, either through updating an existing profile or adding a new one, a query of the potential target database is performed. Performing the query allows profile change module 101 to determine whether the request, if implemented, will match information associated with a potential target. Depending on the level of a match, profile change module 101 may approve the requested profile change/update, deny the request, or notify the user that more information is needed to confirm that the identity of the requestor is genuine.

Potential target database module 104 includes the previously mentioned potential target database, as well as modules used for querying and updating the database (as discussed further below). The entries in the potential target database are directed to those entities, individuals or organizations, that have been identified as being potential targets for impersonation by a malicious individual, which may result in that individual receiving payments from fraudulent transactions. The potential target database may include entries for both account holders of the transaction service as well as non-account holders. When a potential target is an account holder, all relevant profile information may be copied from a user database in the transaction service user database module into the corresponding entry of the potential target database. This in turn provides additional information that can be used by profile change module 101 in determining whether a request to change a user profile is an attempt to impersonate the potential target.

Transaction service user database module 105 as shown here includes the previously mentioned user database having a number of entries directed to storing profiles for users of the transaction service. When a profile change request is received for an existing user, profile change module 101 requests and receives the corresponding user profile as part of the process of evaluating whether the profile update is to be approved. When a decision to approve an update the profile of an existing user, or add a profile for a new user, the approved update is forwarded from profile change module 101 to transaction service user database module 105.

Populating of the potential target database in the embodiment shown is performed by Internet bot 102. Internet bot 102 scan Internet websites in search of information that can be used to identify potential targets. This may include scanning websites, publicly available portions of social networks, crowdfunding sites, and so on. Internet bot 102 may, for example, identify news articles directed to persons that would be potential targets for impersonation. It is noted that information regarding a given potential target may be obtained by Internet bot 102 from multiple websites. In identifying potential targets, Internet bot 102 may execute one or more machine learning models, which may include performing natural language processing (NLP) for, e.g., a news article. Upon identifying a potential target, Internet bot 102 forwards the identity of the potential target and relevant information to potential target database module 104, where the information is then stored in the potential target database. For example, a machine learning model may have been trained to detect Internet documents that reference an individual or organization that is trending (e.g., on social media), has a potential financial need (e.g., a flood victim), or is otherwise noteworthy (a noted activist who solicits money for various causes).

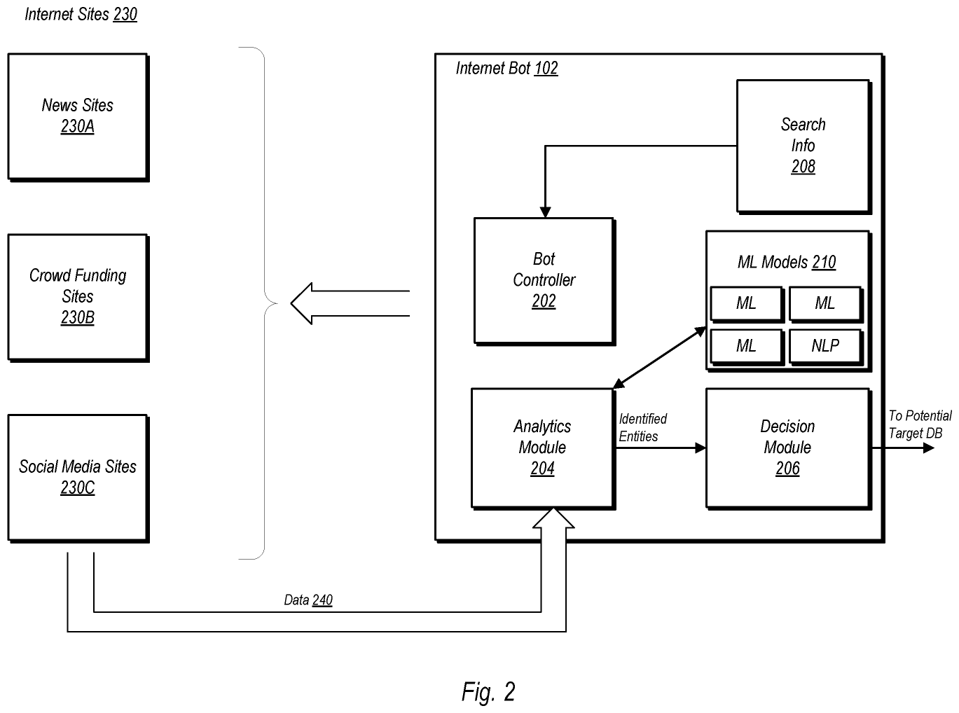

FIG. 2 is a block diagram of one embodiment of an Internet bot. In the embodiment shown, Internet bot 102 includes a bot controller 202, a search information module 208, an analytics module 204, a decision module 206, and machine learning modules 210. Using these various modules, Internet bot 102 may obtain information from various Internet sites 230 and determine the identities of potential targets that may be impersonated using transaction system 100.

The scan of Internet web sites 230 is performed under the control of bot controller 202. The scanning can include news sites 230A, crowd funding sites 230B, and social media sites 230C, although the disclosure is not limited to these particular examples. Bot controller 202 may conduct its scan of various web sites in accordance with various known web crawling technologies, which may involve accessing information included in search information 208 (shown as located within bot 102, but this information may also be located external to bot 102). Such criteria may specify types of websites to search, types of news articles to scan, types of information to obtain (e.g., names, locations, relevant photos, etc.), influencers followed on social networks, and so on. In some embodiments, search information 208 may be arranged to accept timely inputs from a user of the system, such as when a newsworthy event occurs that could result in persons or entities becoming potential targets. Internet bot 102 may also use information from saved searches that would allow a user of the system to create keyword searches that could be saved by a search engine. These queries could be manually set by a user of the system, or programmed into the system to be performed on a predetermined schedule.

Data 240 gathered by bot controller 202 may be provided to analytics module 204. In the embodiment shown, analytics module 204 may perform operations such as sorting through obtained data 240, determining which portions of data 240 are relevant, discarding irrelevant data, and so on. In general, an object of Internet bot 102 is to identify, using analytics module 204, those Internet documents that have characteristics that corresponds to documents that identify individuals/entities who may be impersonated using transaction system 100. One way of accomplishing this objective is for analytics module 204 to access a machine learning model 210 in order to determine whether the document in question should be considered for further evaluation. One example of a machine learning model is a natural language processing (NLP) module that can not only examine the text of an Internet document to determine if it is of interest (e.g., potentially indicative of a possible payment transaction), but also to extract any specific users/entities from the document (e.g., the name of a specific flood victim whose home has been destroyed). In general, analytics module 204 scan documents and other information obtained from Internet sites 230 and determine not only names of relevant persons/entities in the article, but other factors such as the “sentiment” of the article. Machine learning models capable of analyzing photos and avatars (and/or corresponding metadata) may also be executed in the analysis process performed by analytics module 204. The output of analytics module 204 is information identifying specific entities that are candidates for inclusion in a potential targets database (which may also be referred to as a spoofing database). Analytics module 204 may also be capable predicting entities that might become potential targets using statistics or other mechanisms.

Information generated from the analysis performed by analytics module 204 is then forwarded to decision module 206. Decision module 206 may not be present in some implementations of transaction system 100. Decision module 206 is included to indicate that there may be some further level of logic between the output of analytics module 206 and the potential targets database (that is, all entities identified by module 204 may not be stored to the potential targets database). Using the information provided, decision module 206 makes a determination of whether a particular person or entity for whom information has been provided constitutes a potential target. Various criteria may be used to determine whether to designate a particular identity as a potential target. For example, if the person/entity for which analysis was performed is seeking donations, but the amount is relatively small (e.g., less than $50), decision module 206 may determine that the person/identity is not a potential target. On the other hand, if decision module 206 receives information indicating that a person is seeking tens of thousands of dollars to pay medical bills, the person may be designated at a potential target, and the relevant information obtained from the Internet may be forwarded to the potential target database. As with search information module 208, decision module 206 may be subject to input from a user of the system described herein to adjust the criteria upon which decisions are made.

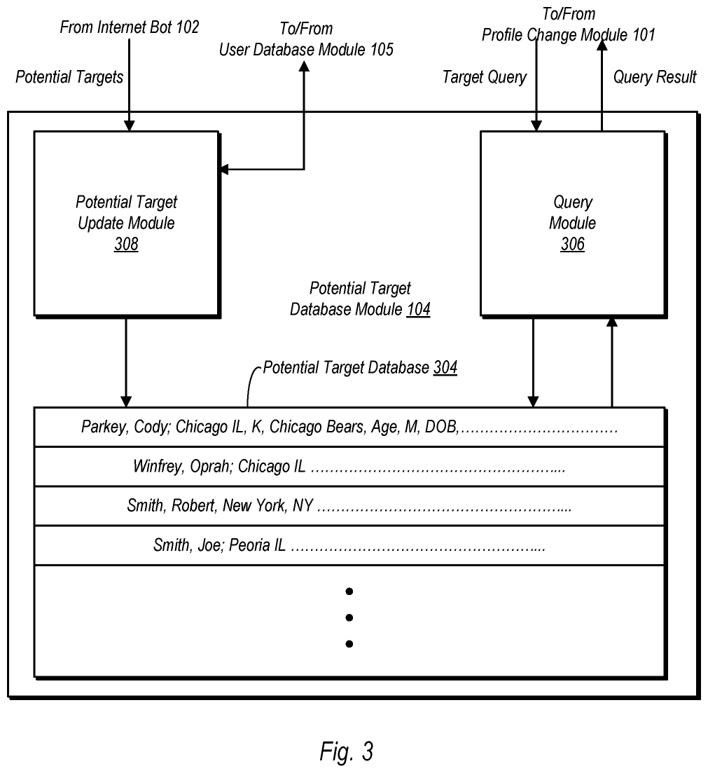

FIG. 3 is a block diagram of one embodiment of a potential target database module. In the embodiment shown, potential target database module 104 includes a potential target database 304, a potential target update module 308, and a query module 306.

Potential target update module 308 receives data from Internet bot 102 when an affirmative decision is made to designate a person or entity as a potential target. Potential target update module 308 then formats the data into the various fields that comprise an entry in potential target database 304. Additionally, potential target update module 308 may also query a user database to determine if the potential target is also an account holder with the transaction service. If it is determined that the potential target is an account holder, profile information from the user database may be provided to potential target update module to be stored along with the corresponding entry in potential target database 304. After obtaining and formatting all information for a given entry, potential target update module 308 writes the date into potential target database 304.

In the embodiment shown, potential target database 304 store entries for potential targets identified by Internet bot 102. These entries can include a name and any other metadata, including a location of the person/entity, a photograph, etc. Since some potential targets may not be account holders with the transaction service, potential target database 304 may include entries directed to non-account holders. For example, celebrities, professional athletes, and others of widespread notoriety may also be identified as potential targets and thus have entries in potential target database 304. (Oprah Winfrey is indicated as an example in FIG. 3.) These entries can be used to prevent another party from attempting to open an account under the identity of the non-account holder identified as a potential target.

As noted above, the overall approach described in this disclosure has two components: 1) identifying potential spoofing targets and 2) using these identified targets to prevent account changes that might lead to fraud. Module 308 writing entries to database 304 relates to the first component. Query module 306 interrogating database 304 relates to the second component.

Query module 306 in the embodiment shown receives information regarding target queries from profile change module 101. For example, suppose a user named “Oprah Jones, Boca Raton, Fla.” changes her profile information to read “Oprah Winfrey, Chicago, Ill.” The desired change may thus be presented by profile change module 101 to query module 306 as a target query. Query module 306 then searches potential target database 304 for one or more potential targets based on the query information received. In searching for a match with a potential target, query module 306 may search the entries of potential target database 304 for matching fields within each entry. For example, matching names can produce a hit in potential target database 304. (Note that a “match” simply means some matching criteria has been satisfied and does not require an exact match on all fields. Thus, a profile update to “Oprah, Chicago, Ill.” may produce a partial hit that nevertheless constitutes a “match” for purposes of transaction system 100. Of course, matches may have different confidence values, which may be used to ultimately determine an action to be taken by system 100.) When a hit is indicated within a given entry, the entirety of that entry may be returned as part of the query result. If the query does not result in any hits corresponding to the information contained therein, query module 306 may indicate that the query produced no hits. These same actions may occur for other entries in the potential target database 304 (e.g., Robert Smith, Joe Smith, and Cody Parkey, as shown in various entries).

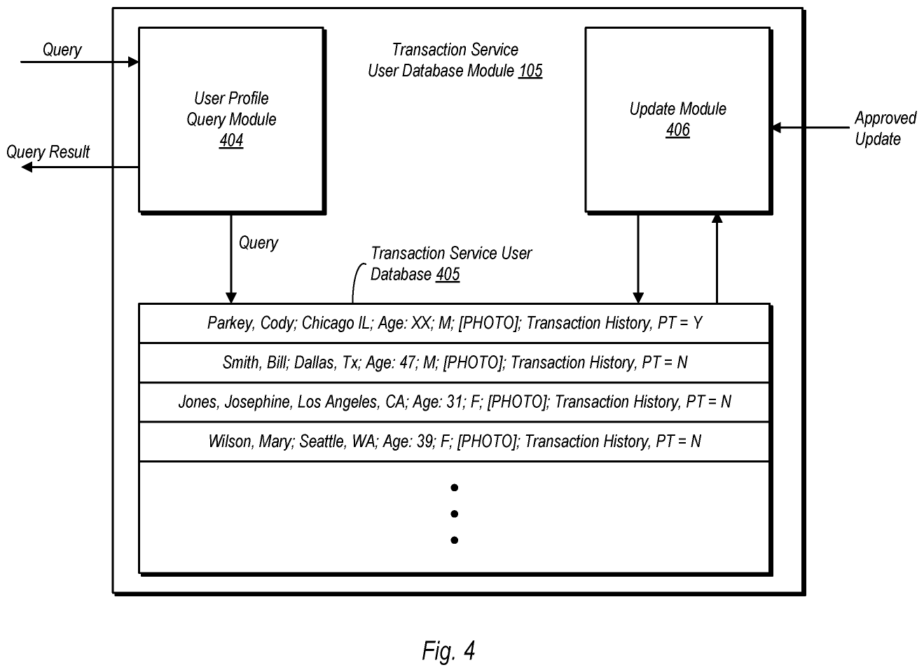

FIG. 4 is a block diagram of one embodiment of a transaction service user database module. In general, user database module 105 stores account profile information for users of transaction system 100, and also handles updates to this information as well as queries for this information. In the embodiment shown, transaction service user database module 105 includes a user profile query module 404, a transaction service user database 405, and an update module 406.

Transaction service user database 405 in the embodiment shown stores profile information for users having an account with the transaction service. The information can include (but is not limited to) a user's name, a nickname or username that is separate from a legal name, age, birthdate, any relevant photos, a history of transactions performed using the transaction service, and various other types of user metadata. In some embodiments, if an account holder of the transaction service has been identified as a potential target, the corresponding entry in transaction service user database may also include a flag or other information indicating the same. The indication “PT=N” in the drawing indicates that the users associated with these entries are not considered potential targets and thus have no corresponding entry in potential target database 304. However, the “Cody Parkey” entry in the illustrated example includes an indication stating “PT=Y”, meaning that Cody Parkey has been designated as a potential target. This flag may be useful when a potential target who is also an account holder attempts a profile update, as some embodiments may employ a different protocol for profile updates of a potential target. When a potential target who is also an account holder attempts a profile update, any new updated media content obtained by Internet bot 102 may also be added to the profile. For example, if a potential target has had a significant change to their hairstyle, as indicated by a photo obtained by Internet bot 102, the indication in their account profile could be used to obtain this photo from potential target database 304 and add it to their user profile in transaction service user database.

User profile query module 404 may receive queries from either profile update module 101 or from potential target database module 104. Profile update module 101 may submit a query responsive to receiving a request to update an existing profile. For example, if Mary Wilson (an example entry shown here) submits a request to update her profile, profile update module 101 submits a query to profile query module for Mary Wilson's profile information. Potential target database module 104 may submit a query responsive to creating a new entry when a potential target is found. For example, if Cody Parkey is placed into potential target database 304, potential target database module 104 submits a query to profile query module 404 as a mechanism for determining if Cody Parkey is also an account holder with the transaction service. Responsive to receiving a query, user profile query module 404 searches transaction service user database 405 for the relevant entry or entries. If an entry indicated by the query is found, information in that entry is returned as a query result. Otherwise, user profile query module 404 provides as the query result an indication that no relevant entry was found.

Update module 406 in the embodiment shown receives information indicating an approved update of a user profile. The information included in the indication may be all information that is being changed for an existing user of the transaction service. For a new account holder of the transaction service, the information may include all information that was submitted for the new profile. Upon receiving this information, update module 406 writes into the existing entry (for existing users making profile changes) or creates a new entry (for new account holders) in transaction service user database 405. Upon completing this task, update module 406 may receive an indication from transaction service user database that the update was successful. For example, when update module 406 submits new information for Mary Wilson responsive to an approved profile update, transaction service user database 405 may return to update module 406 an indication that the information was successfully stored therein once the operation is complete.

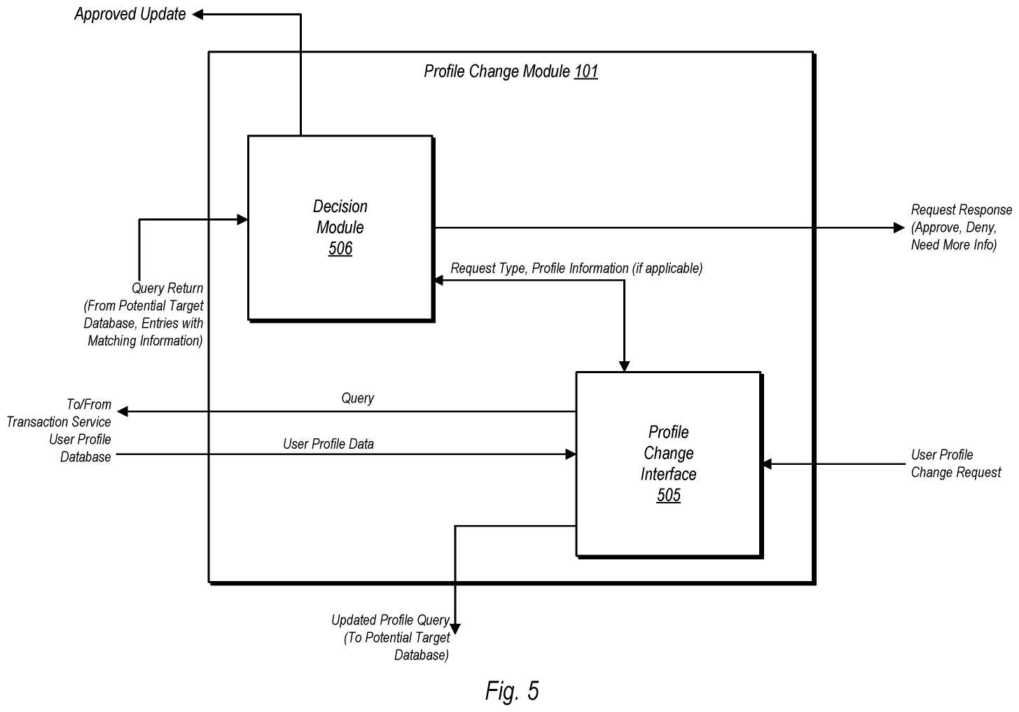

FIG. 5 is a block diagram of one embodiment of a profile change module. Profile change module 101 is configured to receive desired user profile changes and then help determine whether such changes should be permitted. As noted above, in some cases, a profile change that corresponds to a potential target specified in database 104 may not be permitted to complete. In the embodiment shown, profile change module 101 includes a decision module 506 and a profile change interface 505.

Profile change interface 505 receives user profile change requests, which as noted above, may be for the change of an existing user profile or the addition of a new user profile. Responsive to receiving a request, profile change interface 505 provides an indication that a request has been received, along with the type of request (new user or existing user) to decision module 506. In the case of the request corresponding to a change to an existing profile, profile change interface sends a query to transaction service user database 105 and receives in return the existing profile data for the user submitting the request. This existing profile data returned from this query can be used as a basis for comparing the existing profile with the (potentially) new profile, and these changes can be considered by decision module 506 in determining whether a request is to be approved. Profile change interface 505 may then merge the data contained in the request with the existing data (e.g., prior to the request) and forward this information to decision module 506. In the case that the profile change request is for that of a new user, profile change interface 505 provides an indication of the same to decision module 506. In response to all profile change requests, profile change interface 505 sends a query to potential target database 304 for the purpose of obtaining data to determine whether the requestors are attempting to impersonate a potential target. A query sent from profile change interface 505 may include information relevant to the requested profile change that can then be used to search potential target database 304.

Decision module 506 in the embodiment shown performs comparison operations and renders a decision as to whether a profile change request is to be approved, denied, or requires more information for verification from a user submitting the request. In some embodiments, decision module may make one or more calls to an external module to help formulate a decision on a particular user profile update. When a query to potential target database 304 is sent from profile change interface 505, the query results are provided to decision module 506. When a query produces hits in the potential target database 304, the query results may include the entirety of entries for which hits were obtained.

Upon receiving the query results, decision module 506 performs comparison operations to determine whether or not to approve the profile update request. The comparison operations include comparing information corresponding to the profile update request (including previous profile information when an existing user is requesting a change their profile) to information in the various entries retrieved from potential target database. Decision module 506 may render a decision based on this comparison, e.g., based on the number of pieces of information in prospective new/updated profile that match information obtained from the various entries retrieved in the query. For example, if only one piece of information associated with the profile update request matches that of an entry retrieved in the query, decision module 506 may determine that the match is not significant, and may approve the request, forwarding the updated profile information to transaction service user database 405. On the other hand, if, e.g., 12 pieces of information associated profile update request match to a particular entry, decision module 506 may deny the request on the likelihood that the requesting party is attempting to impersonate the potential target associated with the particular entry. In various embodiments, certain pieces of user profile content (e.g., name) may be weighted more heavily than other pieces of content.

As noted above, decision module 506 may also render a decision that results in a request for more information from the party that initiated the request. For example, if the profile information for the user making the request matches some threshold amount of information in the potential target database, decision module 506 may indicate to the user that more information is required before the request can be approved or denied. In this case, decision module 506 may also indicate the further information that is requested. Thus, if there are pieces of information corresponding to the requesting user not available in their profile but available in a particular entry from potential target database 304 (e.g., a state driver's license number), decision module 506 may request that the user provide this information. The user may then be required to respond within a given time period, with a decision of denial being issued should the user fail to do so.

Some examples are now provided to further illustrate the operation of decision module 506. Consider an existing user named ‘Bob Smith’ that wishes to update the name in their profile to ‘Robert Smith’ (as shown in an entry of in the example potential target database 304 of FIG. 3). In such an instance, profile change interface 505 queries potential target database 304 with information from Bob/Robert Smith's profile. During the query, any entry corresponding to a potential target with the name ‘Robert Smith’ or ‘Bob Smith’ may be returned to decision module 506. Matches of additional information, if any (e.g., occupation, photo, etc.), may also trigger an entry to be returned as part of the query result. Upon receiving entries returned from the query of potential target database 304, decision module compares the information from the requestor to information in each of the entries. If, for example, the only matching information between the requestor and the potential targets is the name, decision module 506 may approve the request. In some cases, a request may be approved even if multiple pieces of information match. Thus, if the requested name (‘Robert Smith’) matches three other entries of that name in Los Angeles, Calif., but no other information matches (e.g., different birth dates, different photographs, etc.), decision module 506 may approve the request since it is likely that a large metropolitan area may have multiple people with the same name.

In another example, a hypothetical user named ‘Bob Smith’ may also request to change his profile name to ‘Pete Johnson’ while also changing his birthdate, location, profile photo, interests indicated in the profile, and current age. Upon a query of potential target database 304, one or more entries having a name of ‘Pete Johnson’ may be returned. In this example, decision module 506 determines that not only does the name corresponding to the requested change match, but the birth date, age, location, photo, and interests listed in the profile also produce a match with an entry from the potential target database 304. Given that the requesting user is attempting to change a number of different data fields to match that of a person having an entry in potential target database, decision module 506 may render a decision to deny the request based on the fact that the profile would be changed significantly and that such changes would match several data fields of an entry in potential target database 304. Note that any suitable matching algorithm may be employed for determining hits within the scope of the present disclosure.

It is noted that some information may be weighted by decision module 506, depending on the particular use case. For example, if a given request produces a matching birthdate and only one other piece of information (e.g., location in a large metro area) with users in potential target database 304, decision module 506 may determine that these matches are not significant enough to warrant a denial, since both of those pieces of information are common to a wide swatch of people. On the other hand, if the user is requesting a significant change in profile (such as in the ‘Pete Johnson’ example given above), decision module 506 may apply additional weight to the birthdate, since the overall number of matches, as well as the information to be changed per the request, may be considered too significant to be coincidental.

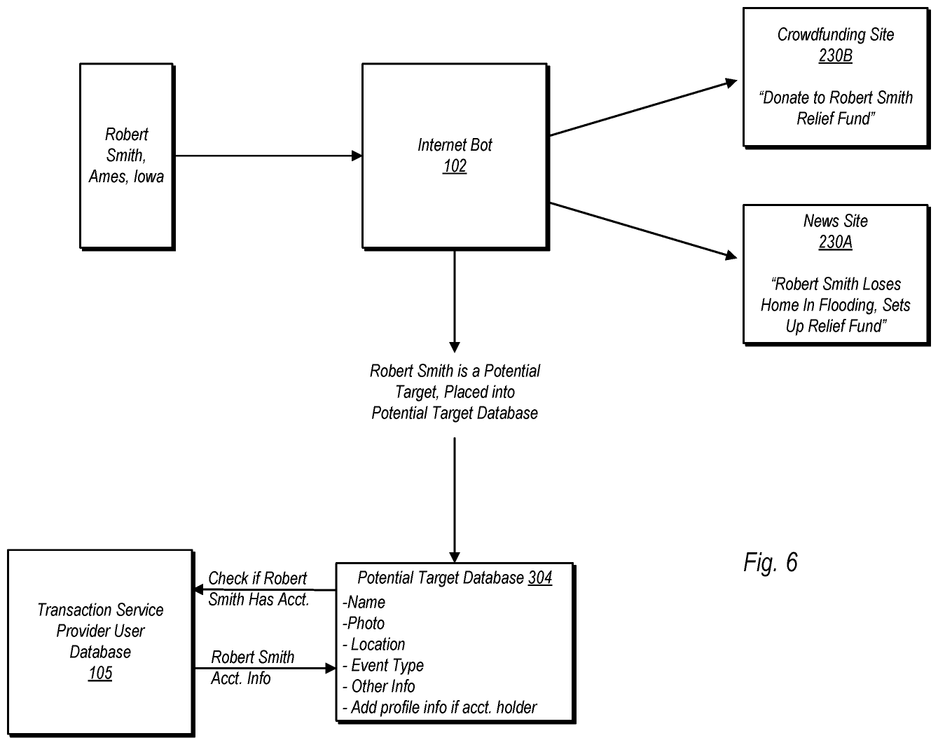

FIG. 6 is a block diagram illustrating the operation of one embodiment of an Internet scan bot. In the illustrated example, Internet bot 102 locates information about a person named Robert Smith of Ames, Iowa, on a news site 230A and a crowdfunding site 230B. On news site 230A, Internet bot 102 finds there is a story about Robert Smith having lost his home due to flooding and will be setting up a relief fund. Meanwhile, Internet bot 102 finds information about the Robert Smith Relief Fund on crowdfunding site 230B. Based on finding this information, Internet bot 102 determines that Robert Smith would be attractive to potential spoofers and thus designates him as a potential target.

Responsive to determining that Robert Smith is a potential target, Internet bot 102 sends all information obtained from news site 230A and crowdfunding site 230B to potential target database 304. The information that may be recorded in the entry may include (but is not limited to) Robert Smith's name, any photos of Robert Smith found on the sites from which information was obtained, location of Robert Smith (Ames, Iowa in this example), event type (Robert Smith lost his home in a flood and is seeking donations), and any other relevant information.

In addition to the above, potential target database module 104 may query transaction service user database 405 to determine if Robert Smith is an account holder with the transaction service. If Robert Smith's information is found in transaction service user database 405, that information is provided and subsequently recorded in the corresponding entry of potential target database 304. This information can then provide an additional basis, along with that gathered by Internet bot 102, for determining when another user is attempting to impersonate Robert Smith.

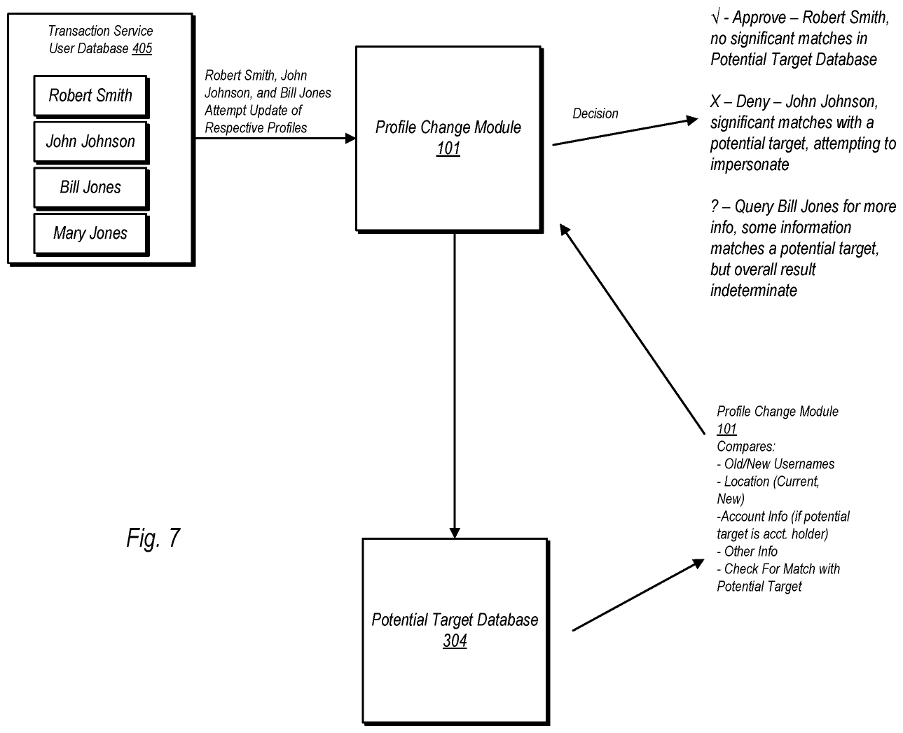

FIG. 7 is a block diagram illustrating operation of one embodiment of a profile change module when an existing user of a transaction processing service attempts to update their respective profile. In this example, Robert Smith, John Johnson, Bill Jones, and Mary Jones are all account holders with the transaction service, and thus have profile entries in transaction service user database 405. Additionally, this example shows that Robert Smith, John Johnson, and Bill Jones are submitting requests to update their respective profiles.

For each of the three profile update requests received in this example, profile change module 101 submits corresponding queries to potential target database 304. The queries may then search for entries stored therein of potential targets having data that at least partially matches the profile information of those persons submitting profile change requests.

Upon receiving the information for each of Robert Smith, John Johnson, and Bill Jones, profile change module 101 performs corresponding comparisons. The information compared for each profile change request can include (but is not limited to) old and new user names, location information, account information (if a potential target returned from potential target database 304 is also an account holder), and any other relevant information. Based on the number and types of matches between data associated with a given profile update request and an entry for a potential target, profile change module 101 determines whether the person requesting the update is trying to impersonate another, and renders an appropriate decision.

In the illustrated example, the request by Robert Smith is approved. This indicates that profile change module 101 did not find any significant matches in potential target database 304. While it is possible for some information provided by Robert Smith to match that of a potential target, in this example, the differentiation was sufficient, the request can still be approved. For example, there may be potential targets having the same name as Robert Smith. However, if the requesting Robert Smith has a different location, age, occupation, photo, and so on than the potential targets that share his name, profile change module may determine that the matching name is not by itself a significant match, and thus can approve the request.

The user John Johnson is denied his request in this example. This indicates that the corresponding query of potential target database 304 produced at least one potential target for which, if the request was approved, the user John Johnson would be a significant match. For example, if the user John Johnson attempted to change his information to match someone of the same name, the same age, and the same location who also listed his occupation as a professional football player, profile change module 101 may deny the request, as the comparison would indicate that the user was trying to impersonate the professional football player.

In the case of Bill Jones, the comparison results are indeterminate, and thus profile change module 101 submits a request for more information. This may occur when profile information for the user Bill Jones matches some information of an entry in the potential target database, but not enough to immediately deny the request. For example, if the user Bill Jones matches a potential target in name, age, location, but no information is provided by the user regarding his occupation, profile change module 101 could submit a request to this user to provide his occupation. Other information could also be requested, such as a valid state driver's license number, banking information, or any other information that could be used to distinguish the user Bill Jones from a potential target that shares other information. Should the user Bill Jones submit, in a timely manner, information that distinguished him from any potential target, the request may be subsequently approved. However, if the user Bill Johnson fails to submit the requested information in a timely manner or submits information that further matches that of a potential target, profile change module 101 may deny the request.

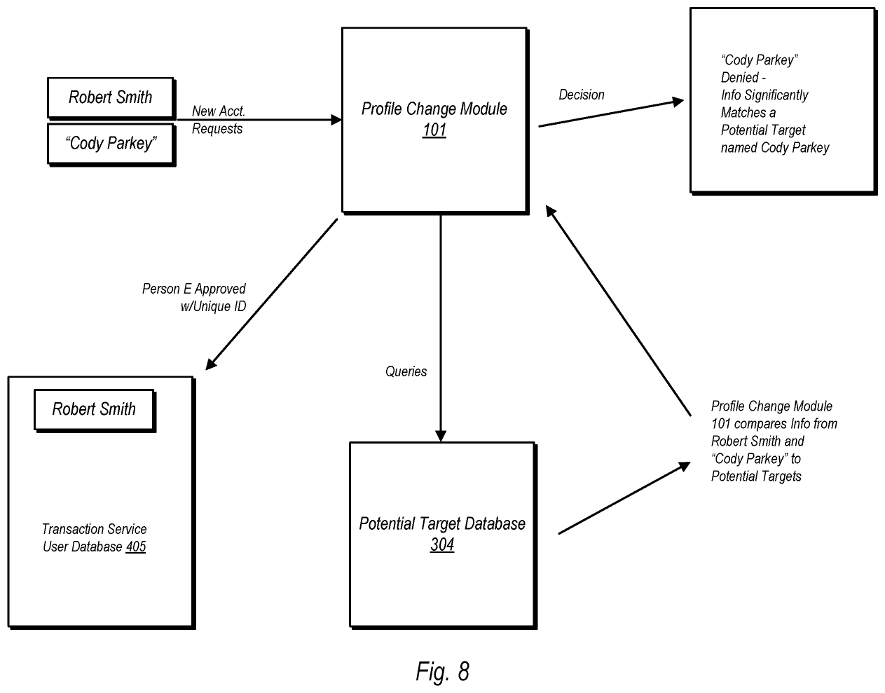

FIG. 8 is a block diagram illustrating operation of one embodiment of a profile change module when a new user of a transaction processing service attempts to add a new profile. In this particular example, Robert Smith and a person alleging to have a name of “Cody Parkey” are submitting new account requests.

Since the requests indicate that neither Robert Smith nor “Cody Parkey” are existing account holders, no query for profile information is made to transaction service user database 405. However, queries are submitted to potential target database 304, and any matches obtained therefrom are provided for comparison. Profile change module 101 then performs comparisons between the information submitted by Robert Smith and “Cody Parkey” to information regarding potential targets obtained from the respective queries of potential target database 304.

In this example, Robert Smith is approved for a new account, and has his profile information placed in transaction service user database 405. The comparison process for Robert Smith in this example may be similar to that of the example provided above with reference to FIG. 7.

On the other hand, the “Cody Parkey” request is denied in this example. The person submitting this profile request may have listed his occupation as a kicker for the Chicago Bears, with the same age, a photo matching the potential target Cody Parkey, and so on. Additionally, if the potential target Cody Parkey is an account holder with the transaction service, profile information module 101 may use that information in determining that the requestor is trying to impersonate him. In general, profile information module 101 determines in this example that the requestor is trying to impersonate a potential target, and the addition of the new account with the requested profile is denied.

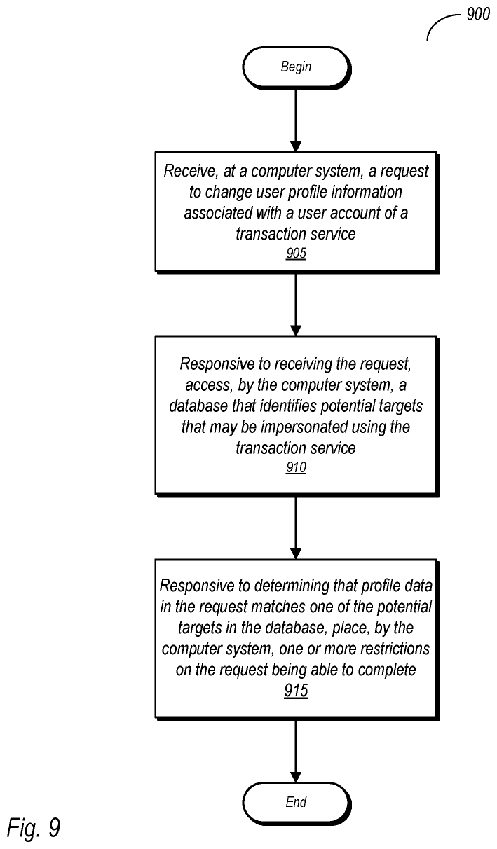

FIG. 9 is a flow diagram illustrating one embodiment of a method for determining whether a user is attempting to use their profile to impersonate another identity. Method 900 may be performed using various embodiments of a profile change module, such as profile change module 101 discussed above with reference to FIGS. 1 and 5.

Method 900 begins with the receiving, at a computer system, a request to change user profile information associated with a user account of a transaction service (block 905). The method further includes, accessing, by the computer system, a database that identifies potential targets that may be impersonated using the transaction service responsive to receiving the request (block 910). Responsive to determining that profile data in the request matches one of the potential targets in the database, Method 900 further includes placing, by the computer system, one or more restrictions on the request being able to complete (block 915).

In one embodiment, the transaction service is a payment service. In such an embodiment, the method includes placing one or more restrictions includes denying the request such that solicitation of payments via the payment service cannot be made from the user account using the profile data. In various embodiments of the method, placing one or more restrictions includes requiring additional information be supplied from a user to verify the request before updating the user profile information.

The user account for which the profile change is requested can be a new user account of the transaction service, and wherein the request to change user profile information is a request to establish the new user account with the transaction service. The user account for which the profile change is requested can also be an existing user account of the transaction service, and wherein the request to change user profile information is a request to update profile information in the existing user account of the transaction service, and wherein the method further comprises comparing old user profile information to information to updated profile information as indicated in the request.

The potential targets in the database are located by a bot executable to scan Internet locations to determine entities associated with potential payment transactions. In performing various embodiments of the method, the database identifies a particular entity that has been located by the bot on a web site and has been classified as a particular potential target by using a machine-learning model. Determining that profile data in the request matches one of the potential targets in the database, in various embodiments of the method, includes accessing transaction information associated with the user account. The method may also include determining if a potential target as identified in the database is an account holder with the transaction service and, responsive to determining that the potential target is an account holder, copying user profile information for the account holder into the database.

With regard to populating and updating the database of potential targets, the method includes scanning Internet locations, using a bot executed on the computer system, to identify entities as potential targets that may be impersonated using the transaction service and storing, by the computer system in a potential target database of a transaction service, one or more of the identified entities as potential targets.

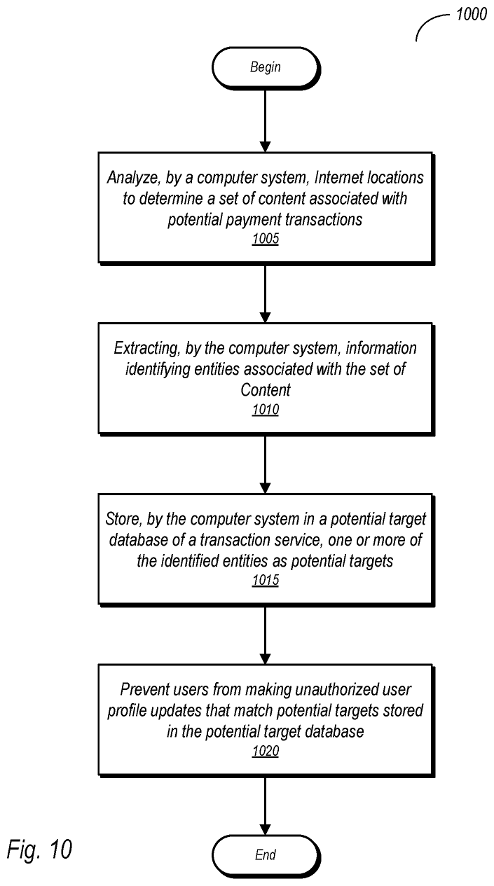

FIG. 10 is a flow diagram illustrating one embodiment of a method of operating an Internet bot to identify potential targets for impersonation. Method 1000 as discussed herein may be performed by various embodiments of an Internet bot, such as Internet bot 102 as discussed above in reference to FIGS. 1, 2, and 6.

Method 1000 includes analyzing, by a computer system, Internet locations to determine a set of content associated with potential payment transactions (block 1005). For example, the computer system may scan various websites (e.g., crowdfunding sites, news sites) for information regarding the solicitation of donations for a particular cause. Method 1000 further includes extracting, by the computer system, information identifying entities associated with the set of content (block 1010). Thus, for example, if the computer system finds a human interest story on a site regarding a particular person who is soliciting donations for a particular cause, that person is identified as being associated with the content of the story. The method continues by storing, using the computer system in a potential target database of a transaction service, one or more of the identified entities as potential targets (block 1015). Thus, the person in the example above may have any identifying information obtained from the scanned websites stored in an entry in the potential target database. The transaction service is configured to prevent users from making unauthorized user profile updates that match potential targets stored in the potential target database (block 1020). Accordingly, the service prevents other users from changing their identity in a manner that would allow them to impersonate a potential target and potentially receive a benefit from transactions to which they are not entitled.

In various embodiments of the method, analyzing Internet locations to determine a set of content associated with potential payment transactions includes executing a machine learning model utilizing natural language processing. The analyzing includes determining if one of the identified entities is a user of the transaction service, as indicated in a user database of the transaction service. Responsive to determining that the one of the identified entities is a user of the transaction service, the method further includes adding information from a corresponding profile stored in the user database to a corresponding entry the potential target database, wherein the information from the corresponding profile is usable to determine that another user requesting a profile update matches user of the transaction service having information stored in the potential target database. Storing the one or more identified entities comprises storing one or more photographic images corresponding to the one or more identities, wherein the photographic images are usable to determine if a user requesting a profile update matches a potential target having information stored in the potential target database.

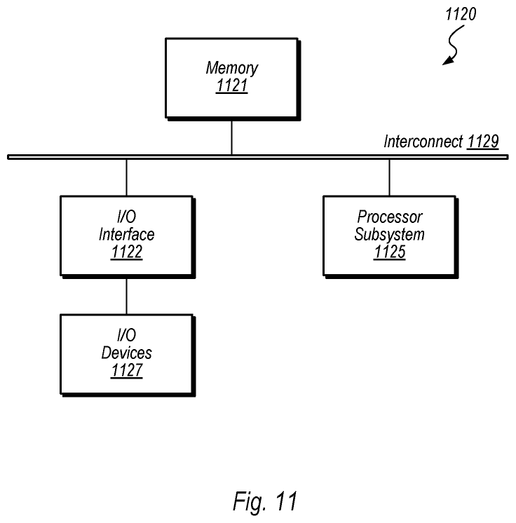

FIG. 11 is a block diagram of one embodiment of an example computer system. Instances of computer system 1120 as shown here may be used to implement the various functional blocks/modules discussed above, e.g., Internet bot 102 of FIG. 1, potential target database module 104 of FIG. 3, and so on.

Computer system 1120 includes a processor subsystem 1125 that is coupled to a system memory 1121 and I/O interfaces(s) 1122 via an interconnect 1129 (e.g., a system bus). I/O interface(s) 1122 is coupled to one or more I/O devices 1127. Computer system 1120 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 1120 is shown in FIG. 11 for convenience, system 1120 may also be implemented as two or more computer systems operating together.

Processor subsystem 1125 may include one or more processors or processing units. In various embodiments of computer system 1120, multiple instances of processor subsystem 1125 may be coupled to interconnect 1129. In various embodiments, processor subsystem 1125 (or each processor unit within 1125) may contain a cache or other form of on-board memory.

System memory 1121 is usable store program instructions executable by processor subsystem 1125 to cause system 1120 perform various operations described herein. System memory 1121 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 1120 is not limited to primary storage such as memory 1121. Rather, computer system 1120 may also include other forms of storage such as cache memory in processor subsystem 1125 and secondary storage on I/O Devices 1127 (e.g., a hard drive, storage array, etc.). In some embodiments, these other forms of storage may also store program instructions executable by processor subsystem 1125. In some embodiments, memory 1121 may include various ones of the modules discussed above, such as remote verification module 104 of FIGS. 1 and/or 3 (and the various sub-modules implemented of the latter), among others.

I/O interfaces 1122 may be any of various types of interfaces configured to couple to and communicate with other devices, according to various embodiments. In one embodiment, I/O interface 1122 is a bridge chip (e.g., Southbridge) from a front-side to one or more back-side buses. I/O interfaces 1122 may be coupled to one or more I/O devices 1127 via one or more corresponding buses or other interfaces. Examples of I/O devices 1127 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1120 is coupled to a network via a network interface device 1127 (e.g., configured to communicate over WiFi, Bluetooth, Ethernet, etc.).

Numerous variations and modifications will become apparent to those skilled in the art once the above disclosure is fully appreciated. It is intended that the following claims be interpreted to embrace all such variations and modifications.

What is claimed is:

1. A method, comprising:
receiving, at a computer system, a request to change user profile information associated with a user account of a transaction service;
responsive to receiving the request, accessing, by the computer system, a database that identifies potential targets that may be impersonated using the transaction service;
responsive to determining the request matches one of the potential targets in the database, placing, by the computer system, one or more restrictions on the request being able to complete.

2. The method of claim 1, wherein the transaction service is a payment service, and wherein the placing one or more restrictions includes denying the request such that solicitation of payments via the payment service cannot be made from the user account using the profile information.

3. The method of claim 1, wherein the placing one or more restrictions includes requiring additional information be supplied from a user to verify the request before updating the user profile information.

4. The method of claim 1, wherein the user account is a new user account of the transaction service, and wherein the request to change user profile information is a request to establish the new user account with the transaction service.

5. The method of claim 1, wherein the user account is an existing user account of the transaction service, and wherein the request to change user profile information is a request to update profile information in the existing user account of the transaction service, and wherein determining that profile information in the request matches one of the potential targets in the database includes combining the profile information in the request with existing user account profile information and using the combined profile information to search the potential targets in the database.

6. The method of claim 1, wherein potential targets in the database are located by a bot executable to scan Internet locations to determine entities associated with potential payment transactions.

7. The method of claim 6, wherein the database identifies a particular entity that has been located by the bot on a web site and has been classified as a particular potential target by using a machine-learning model.

8. The method of claim 1, wherein determining that profile data in the request matches one of the potential targets in the database includes accessing transaction information associated with the user account.

9. The method of claim 1, further comprising:
determining if a potential target as identified in the database is an account holder with the transaction service; and
responsive to determining that the potential target is an account holder, copying user profile information for the account holder into the database, wherein the user profile information is usable to determine whether the profile information in the request is a match with one of the user profiles in the database.

10. The method of claim 1, further comprising:
scanning Internet locations, using a bot executed on the computer system, to identify entities as potential targets that may be impersonated using the transaction service; and
storing, by the computer system in a potential target database of a transaction service, one or more of the identified entities as potential targets.

11. A method, comprising:
analyzing, by a computer system, Internet locations to determine a set of content associated with potential payment transactions;
extracting, by the computer system, information identifying entities associated with the set of content; and
storing, by the computer system in a potential target database of a transaction service, one or more of the identified entities as potential targets;
wherein the transaction service is configured to prevent users from making unauthorized user profile updates that match potential targets stored in the potential target database.

12. The method of claim 11, wherein analyzing Internet locations to determine a set of content associated with potential payment transactions includes executing a machine learning model utilizing natural language processing.

13. The method of claim 11, further comprising:
determining if one of the identified entities is a user of the transaction service, as indicated in a user database of the transaction service; and
responsive to determining that the one of the identified entities is a user of the transaction service, adding information from a corresponding profile stored in the user database to a corresponding entry the potential target database, wherein the information from the corresponding profile is usable to determine that another user requesting a profile update matches user of the transaction service having information stored in the potential target database.

14. The method of claim 11, wherein storing the one or more identified entities comprises storing one or more photographic images corresponding to the one or more identified entities, wherein the photographic images are usable to determine if a user requesting a profile update matches a potential target having information stored in the potential target database.

15. A system, comprising:
one or more processor units;
memory storing program instructions executable by the one or more processor units to:
store updates to a potential target database of potential targets for whom transactions may be spoofed via a transaction service using identity information of the potential targets;
maintain user profile information for a plurality of user accounts of the transaction service;
receive a request to update user profile information for a particular one of the plurality of user accounts; and
in response to determining that information included in the request matches one of the potential targets in the potential target database, blocking the request.

16. The system of claim 15, wherein the memory stores instructions executable by the one or more processor units to scan and analyze Internet locations to identify potential targets to be stored in the potential target database.

17. The system of claim 16, wherein the instructions executable to scan and analyze Internet locations includes instructions that, when executed by the one or more processors, execute a machine learning model utilizing natural language processing.

18. The system of claim 15, wherein the instructions executable to scan and analyze Internet locations includes instructions that, when executed by the one or more processors, scan news articles appearing on one or more internet websites.

19. The system of claim 15, wherein the memory stores instructions executable by the one or more processor units to determine if an entity identified as a potential target has a user account with the transaction service, and, responsive to determining that the potential target has a user account, copy user profile information corresponding to the user account to the potential target database.

20. The system of claim 15, wherein the instructions executable to determine that information included in the request matches one of the potential targets in the potential target database includes instructions that, when executable by one or more of the processor units, generate a sample profile with the updated information, compare the sample profile with a profile of the potential target, and compare the sample profile with a previous profile of a user submitting the request.
